(19) United States
(12) Patent Application Publication
(10) Pub. No.: US 2025/0173690 A1
(43) Pub. Date: May 29, 2025

(54) CRYPTOCURRENCY PROTOCOL WITH BUILT-IN INTERVENTION RESPONSIVE TO A CRYPTOCURRENCY EXCHANGE RATE

(71) Applicant: CELO FOUNDATION, San Francisco, CA (US)

(72) Inventors: Nader AL-NAJI, New York, NY (US); Lawrence DIAO, New York, NY (US); Brian FREYBURGER, New York, NY (US)

(21) Appl. No.: 18/390,492

(22) Filed: Dec. 20, 2023

Related U.S. Application Data
(63) Continuation of application No. 15/973,918, filed on May 8, 2018, now abandoned.

(51) Int. Cl. G06Q 20/06; G06Q 20/36

(52) U.S. Cl. CPC G06Q 20/0658; G06Q 20/3678; G06Q 2220/00

(57) ABSTRACT

The disclosure relates to an improved technology protocol for a distributed cryptocurrency system with built-in measures to mitigate volatility of a subject cryptocurrency. The distributed cryptocurrency system may include a number of computer nodes connected via a network. At least some of the nodes may programmatically implement all or portion of a cryptocurrency protocol that programs the nodes to stabilize the value of a subject cryptocurrency. As such, the protocol includes a distributed, decentralized set of programmatic rules for mitigating price volatility of the cryptocurrency. The protocol may include a state determination mechanism to assess whether interventive actions to stabilize a value of the cryptocurrency is triggered. The protocol may electronically expand or contract the supply of the cryptocurrency through use of three different types of electronic tokens that are functionally distinct from one another and that each play a role in expanding or contracting the supply of the cryptocurrency.

### FIELD OF THE INVENTION

The invention relates to an improved cryptocurrency protocol with built-in mechanisms to electronically expand or contract the supply of a cryptocurrency in response to exchange rate indications from a plurality of nodes of a cryptocurrency network.

### BACKGROUND OF THE INVENTION

Various cryptocurrencies are known. One of the leading ones is Bitcoin. Bitcoin is a currency used in the bitcoin network, which is a peer-to-peer payment network that operates on a cryptographic protocol using a distributed ledger technology. The protocol is described in a white paper entitled “Bitcoin: A Peer-to-Peer Electronic Cash System.”

Users send and receive bitcoins, the units of currency, by broadcasting digitally signed messages to the network using a cryptocurrency wallet software. Transactions are stored in a distributed, replicated public database known as the blockchain, with consensus achieved by a proof-of-work system called mining. The bitcoin blockchain is one example of a decentralized, distributed ledger technology. Other cryptocurrencies, blockchains and distributed ledgers are known.

Various problems exist with these protocols and the technology behind them. One of the problems with this technology protocol is that there typically is no technical mechanism to ensure price stability, resulting in a high level of price volatility. This leads to numerous problems, one of which is the reluctance of bitcoin holders to spend the coins for fear the price will rise significantly after the coins are spent. Other problems and technical limitations with this and other cryptocurrency protocols are well-known.

### SUMMARY OF THE INVENTION

One aspect of the invention relates to an improved technology protocol for a distributed cryptocurrency system with built-in measures to mitigate volatility of a subject cryptocurrency. The improved technology protocol will be referred to herein as the “basecoin cryptocurrency protocol” for convenience. The distributed cryptocurrency system may include a plurality of computer nodes connected via a network. Each of the nodes (or at least a plurality of the nodes) may programmatically implement all or portion of the basecoin cryptocurrency protocol to stabilize the value of a subject cryptocurrency. As such, the basecoin cryptocurrency protocol includes a distributed, decentralized set of programmatic rules for mitigating price volatility of the subject cryptocurrency.

One aspect of the improved technology protocol includes the creation of three types of tokens. including a first token type, a second token type and a third token type (where each type is functionally different than the other two, as explained below). The protocol also specifies a pegged asset (e.g., USD, another fiat currency, an index such as the Consumer Price Index (CPI), a basket of goods or some other asset). The protocol also defines a peg ratio which is predetermined ratio of the value of the first token type to the value of the pegged asset.

The basecoin cryptocurrency protocol may include a technical implementation to programmatically evaluate an exchange rate of the cryptocurrency relative to the pegged asset. The protocol may include a state determination mechanism to assess the peg ratio and trigger a process, specified by a set of stored rules, that cause interventive actions depending on whether peg ratio is too high or too low. For example, the basecoin cryptocurrency protocol may programmatically intervene to stabilize the exchange rate by electronically expanding or contracting the supply of the first token type that is in electronic circulation until the desired peg ratio is re-established.

If the value of the first token gets too high, the system will create a certain number of additional first tokens to devalue the first tokens until the desired peg ratio is met. For example, the basecoin cryptocurrency protocol may generate one or more units (or portions of a unit) of the cryptocurrency to increase the supply by writing one or more blocks to the blockchain that each indicate the creation of at least a portion of a unit of the cryptocurrency.

If the value of the first token is too low, the system will shrink the supply (for example, as detailed below) until the desired peg ratio is met. The basecoin cryptocurrency protocol may burn one or more units (or portions of a unit) of the cryptocurrency to decrease the supply by writing one or more blocks to the blockchain that each indicate the destruction or inactivation of at least a portion of a unit of the cryptocurrency.

Other ways to create or destroy units of the cryptocurrency may be used, the results of which may be stored on a blockchain, which may be stored at some or all of the nodes.

By generating or burning units of the cryptocurrency, the basecoin cryptocurrency protocol may programmatically control the quantity of the cryptocurrency in circulation in a distributed (i.e., decentralized) and automated manner. In this way, the basecoin cryptocurrency protocol may automatically control the quantity of the cryptocurrency to achieve the target exchange rate and/or target level of volatility to address volatility that arises out of the use of blockchain for other cryptocurrencies. As another benefit, the basecoin cryptocurrency protocol achieves stability without the control of a single (centralized) actor and without subjective judgement calls that can exacerbate such volatility.

The basecoin cryptocurrency protocol includes built-in rules that programmatically encode triggering events for intervention and intervening behavior to exhibit (e.g., whether and how such intervention is to increase or decrease the supply of the subject cryptocurrency). For example, responsive to a determination that a value of the subject cryptocurrency is too high, the basecoin cryptocurrency protocol may create additional units of the cryptocurrency. On the other hand, responsive to a determination that a value of the subject cryptocurrency is too low, the basecoin cryptocurrency protocol may burn units of the cryptocurrency. In other examples, market or other information besides value of the subject cryptocurrency may be used as well. One example of such other information may include market sentiment information, exchange volume, and/or other information that can be used to trigger behavior to exhibit. In some instances the behavior to exhibit may be driven by votes from oracles in an oracle subsystem, which is described below. Generally speaking, the oracles may each cast a vote that indicates a quantity of the subject cryptocurrency that should be increased or decreased (or remain the same). The median quantity may be selected by consensus and this median quantity may be used to alter (or not alter if zero) the supply of the subject cryptocurrency.

By way of illustration and not limitation, examples of cryptocurrency implementations, and programmatic ways in which to intervene in response to the cryptocurrency exchange rate determined by the distributed oracle subsystem will now be described.

In an implementation, the basecoin cryptocurrency protocol may use three types of electronic tokens to stabilize a subject cryptocurrency. By managing these three types of tokens and storing transactions relating to these tokens on the blockchain, the basecoin cryptocurrency protocol may stabilize the subject cryptocurrency in a distributed fashion.

A first type of electronic token may include the subject cryptocurrency, whose value is stabilized by the basecoin cryptocurrency protocol. The first type of electronic token may be used as a medium of exchange. Transactions using this type of electronic token may be recorded on the blockchain in a manner similar to those of other cryptocurrencies like Bitcoin. Although this first type of token may be created and destroyed by the built-in mechanisms of the basecoin cryptocurrency protocol, they do not have a specified expiration date. The first type of token may be referred to herein as a “basecoin.”

A second type of token represents a future claim to a unit of the first token type at some point in the future. For example, the second type of token may be issued to a user if the user agrees to exchange a unit of basecoin owned by the user in order to receive the second type of token. In exchange, the basecoin cryptocurrency protocol may issue a second type of token to the user, usually at a discount to the value of the first token-type to incent the user to relinquish a unit of the first token type and accept a unit of the second type of token. The unit of basecoin obtained in this manner may be digitally burned. In this way, issuance of the second type of token may reduce the immediate supply of basecoins in circulation. It may also provide a source for increasing the supply at a later date by exchanging the second type of token with the first type of token. The second type of electronic token may be referred to herein (for convenience as a basebond).

Each instance of a second type of token may have an expiration date that is calculable from the recorded issuance date or other expiration that is recorded to the blockchain. The term is determined by the basecoin cryptocurrency protocol, e.g., some set period after an instance of the second toke type was issued.

The protocol includes a set of rules defining conditions under which the second tokens are redeemed. The rules are: (i) that the blockchain has determined that an expansion of the first token type supply is necessary; (ii) the term of the instance of a second token type has not expired; and (iii) all of the second token types that were issued before this instance of the second token type have been redeemed or have expired. In some implementations, a preferred version of the second type of token may be issued. This preferred token may never expire, be placed in a Last-In-Last-Out (“LIFO”) queue and be paid after basebonds and before baseshares (a third type of electronic token described below).

A third type of electronic token may represent a right of its owner to receive a unit of the first type of token, such as when the basecoin cryptocurrency protocol determines that the supply of the first type of token should be expanded. The supply of the third type of electronic token may be fixed at the genesis of the blockchain, but the supply may be adjusted up or down over time. For example, the supply may be increased periodically at a predefined rate (such as 5% per year) or decreased periodically at the same or different predefined rate. They are not pegged to anything, and their value stems from a contingent right to receive first types of tokens under certain conditions. For example, when demand for first type of tokens goes up and the basecoin cryptocurrency protocol creates new first type of tokens to match demand, holders of the third electronic tokens receive the newly-created first type of coins pro rata. The foregoing may be subject to one or more conditions, such as all of the basebonds must have been redeemed beforehand. The second type of electronic token may be referred to herein (for convenience as a baseshare).

The basecoin cryptocurrency protocol may include various built-in mechanisms for contracting the number of basecoins in circulation responsive to the value of the basecoin falling below a target value and/or other trigger that causes the number of basecoins in circulation to be contracted. By contracting the supply of basecoins, the value of a unit of the basecoin may tend to be increased.

One exemplary mechanism of reducing the basecoin supply is by offering an trade of basebonds for basecoins. The basecoin cryptocurrency protocol may incent holders of basecoins to give up one or more units of their basecoins and in return receive a basebond. In some instances, a basebond may expire after a fixed time period set by the basecoin cryptocurrency protocol and become valueless. In some instances, the basebond expiration may be set dynamically based on the value of the basecoin. The basecoin cryptocurrency protocol may burn the basecoins obtained in this manner.

Issued basebonds may be later exchanged for further basecoins (or other units of value) when the supply of basecoins needs to be expanded. The basecoin cryptocurrency protocol may maintain a listing of the issued basebonds in a first-in, first-out (FIFO) queue and written to the blockchain. Other types of queues may be used as well, such as a LIFO queue or unordered pool of entries, according to particular needs. Basebonds may be selected for redemption based on the FIFO queue subject to certain conditions being met (such as whether the basebond has expired and whether the supply of basecoins should be expanded).

Another exemplary mechanism of reducing the basecoin supply is by offering a trade of baseshares for basecoins. The basecoin cryptocurrency protocol may incent holders of basecoins to give up one or more units of their basecoins and in return receive a baseshare. Each baseshare may entitle the holder to receive a new supply of basecoins when the basecoin cryptocurrency protocol determines that the basecoin supply should be expanded. The basecoin cryptocurrency protocol may then burn the basecoins obtained in this manner.

In some instances, the basecoin cryptocurrency protocol may cause baseshares to decay at a certain rate, such as 5% per year. Other decay rates may be used as well. For example, a holder of 100 baseshares will hold 95 baseshares after one round of decay. The basecoin cryptocurrency protocol may store the decayed baseshares in a baseshare pool that includes baseshares that are available to be sold in exchange for basecoins. The decay event may be written to the blockchain. Thus, the baseshare pool may provide a supply of baseshares that can be exchanged for basecoins, where are burned thereby reducing the basecoin supply. Alternatively, the baseshares may be increased at a certain rate. The increase may also be written to the blockchain. In some instances, the baseshares that were increased at the certain rate may be added to the baseshare pool that includes baseshares that are available to be sold in exchange for basecoins.

One exemplary mechanism of expanding the basecoin supply is by redeeming basebonds. In this example, the basecoin cryptocurrency protocol may provide basebond holders basecoins in exchange for basebonds, according to the FIFO queue recorded on the blockchain. In some instances the foregoing may be subject to the basebond not having expired. For example, if a basebond has not expired, and it is next in the FIFO queue to be paid, it may get distributions up to its face amount. In some instances, partial redemptions are not permitted; instead, once a partial distribution has been made, the basebond may remain at the front of the FIFO queue. For example, assuming a basebond has a face value of one unit of cryptocurrency on Jan. 1, 2019. On Jan. 1, 2020 an expansion occurs which pays 0.20 units per basebond; on May 1, 2022 there's another that pays 0.75 per basebond. The basebond is still potentially entitled to 0.05. However on Jan. 1, 2025 the basebond may expire and become valueless. In this example, there must have been no additional expansions between May 1, 2022 and Jan. 1, 2025 because once a basebond gets a payment, it remains at the front of the FIFO queue, and will remain there until it's rights are paid in full. In this manner, the supply of basecoins in circulation is increased as necessary.

In another exemplary mechanism of expanding the basecoin supply, the basecoin cryptocurrency protocol may provide new basecoins to holders of baseshares. The basecoin cryptocurrency protocol may do so pro rata amongst all holders of baseshares. Furthermore, the basecoin cryptocurrency protocol may provide basecoins to baseshare holders only after there are no basebonds that are available for redemption (e.g., when all unexpired basebonds have already been redeemed for basecoins). It should be noted that issuance of new basecoins to baseshare holders may not require the baseshare holders to provide anything in return (other than being a baseshare holder). It should also be noted that the baseshares in the baseshare pool resulting from baseshare decay are not provided with basecoins; only actual baseshare holders are provided with basecoins.

In some implementations, the basecoin cryptocurrency protocol may maintain a separate cryptocurrency for different regions. For example, each regional economy to have its own basecoin cryptocurrency protocol that can respond independently to local demand shocks. This is because demand shocks can concentrate in a particular region, almost in complete isolation from the rest of the world. In some implementations, the different regions may be associated with their own cryptocurrency pegged to the same value (e.g., fiat currency, basket of goods, etc.) as another region's cryptocurrency or different value. For example, each of two regions' cryptocurrency may be pegged against a U.S. dollar or the same basket of goods. Alternatively, one region's cryptocurrency may be pegged against one fiat currency or basket of goods while another region's cryptocurrency may be pegged against another fiat currency or basket of goods.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an exemplary system for implementing a cryptocurrency protocol with built-in interventive response mechanisms to cryptocurrency exchange rates, according to an implementation of the invention.

FIG. 2 illustrates an exemplary data flow for determining a exchange rate of a cryptocurrency based on multiple inputs from different users that are validated in a decentralized and peer-to-peer cryptocurrency network, according to an implementation of the invention.

FIG. 3 illustrates an exemplary data flow for selecting a exchange rate of a cryptocurrency from among multiple inputs from different users in a peer-to-peer cryptocurrency network, according to an implementation of the invention.

FIG. 4 illustrates an exemplary data flow for programmatically intervening to adjust a exchange rate of a cryptocurrency based on a peer validated consensus of a current exchange rate of the cryptocurrency, according to an implementation of the invention.

FIG. 5 illustrates a process for stabilizing the value of a cryptocurrency, according to an implementation of the invention.

FIG. 6 illustrates a process for obtaining an exchange rate that indicates a value of a cryptocurrency relative to another unit of value from a plurality of nodes of a cryptocurrency network, according to an implementation of the invention.

FIG. 7 illustrates a schematic diagram of a contraction and expansion mechanism using basebond issues and redemptions, according to an implementation of the invention.

FIG. 8 illustrates a schematic diagram of a contraction and expansion mechanism using baseshare sales and pro rate distribution of newly created basecoins, according to an implementation of the invention.

### DETAILED DESCRIPTION OF THE INVENTION

The invention described herein relates to a system and method of implementing a cryptocurrency protocol with built-in interventive response mechanisms to stabilize the value of a cryptocurrency, according to an implementation of the invention.

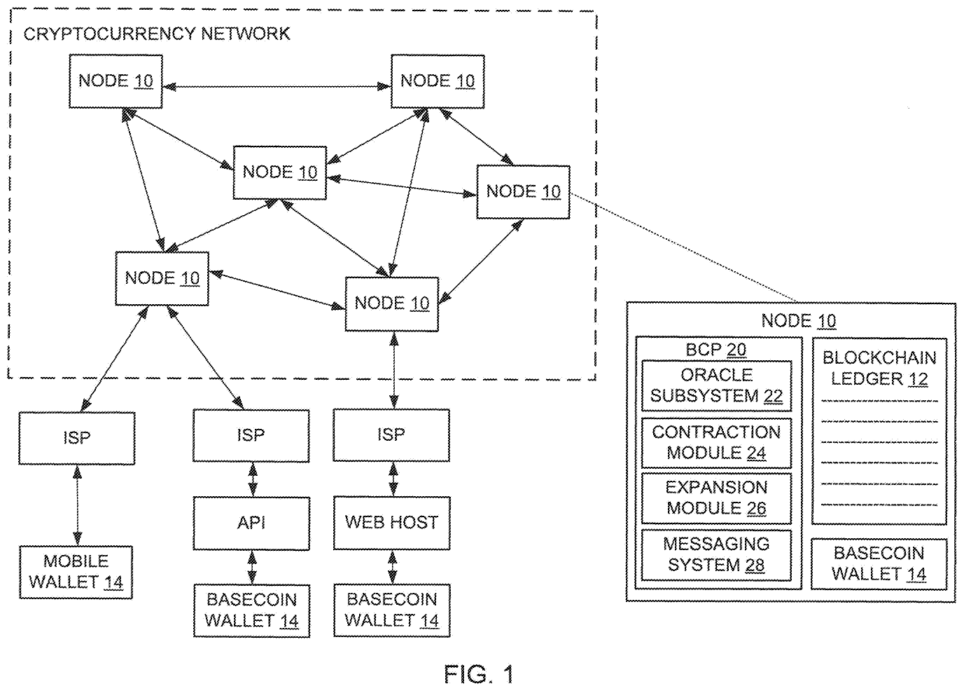

FIG. 1 illustrates an exemplary system 100 for implementing a cryptocurrency protocol with built-in interventive response mechanisms to stabilize the value of a cryptocurrency, according to an implementation of the invention. The distributed cryptocurrency system may include a plurality of computer nodes (“nodes 10”) connected via a network, such as a wide area network like the Internet. Access to the network may be provided by an Internet Service Provider (“ISP 2”). Each of the nodes 10 (or at least a plurality of the nodes 10) may implement a blockchain ledger 12, a basecoin wallet 14, and a basecoin cryptocurrency protocol (“bcp 20”). Each node 10 may programmatically implement all or portion of the foregoing to stabilize a subject cryptocurrency (FIG. 1 illustrates only a single node 10 in detail for convenience of illustration).

The blockchain ledger 12 may include a distributed way in which information related to the system 100 is stored and retrieved. Blockchain ledger 12 may be implemented in a manner similar to blockchains used by Bitcoin or other cryptocurrencies. The blockchain ledger 12 may store various types of entries such as, without limitation, transactions involving purchases using basecoin, consensus decisions described herein, and/or other information relating to the cryptocurrency network. Furthermore, although a single blockchain ledger 12 (a full or partial copy of which is stored in each of the nodes 10) is described, multiple types of blockchain ledgers may be stored. For example, one type of blockchain ledger may store user account/transaction information, while another blockchain ledger may store information relating to exchange rates of the cryptocurrency.

The basecoin wallet 14 may include an application executing on a given node 10. In these instances, the node 10 is a user-operated device that participates in the cryptocurrency network and executes the basecoin wallet 14 to make purchases and interact with the cryptocurrency network. Such interaction may be mediated by an API or a web host, or direct to other nodes via ISP 2. The basecoin wallet 14 may be associated with a user account that stores the number or units of basecoin held by a user associated with the user account. The user account may be stored externally on an independent database (e.g., associated with the web host), and/or may be stored on the blockchain ledger 12.

The bcp 20 may include a distributed manner of programmatically evaluating a exchange rate (e.g., value) of the cryptocurrency and triggering built-in interventive actions responsive to the cryptocurrency exchange rate. Thus, if the cryptocurrency exchange rate deviates from a target exchange rate and/or target level of volatility, the bcp 20 may programmatically (e.g., automatically without user intervention) intervene to restore the target exchange rate and/or target level of volatility. The bcp 20 may include, without limitation, an oracle subsystem 22, a contraction module 24, an expansion module 26, a messaging system 28, and/or other components. Each of the nodes 10 may implement all or a portion of the bcp 20. As such, the bcp 20 includes a distributed, decentralized set of programmatic rules for mitigating volatility of the subject cryptocurrency.

### Secure Consensus Decisioning

The bcp 20 may employ built-in secure consensus decisioning based on input from a plurality of nodes 10. “Consensus decisioning” refers to a process by which the cryptocurrency network makes a decision if a consensus of nodes 10 agrees on the decision. A consensus may be defined as a certain proportion of nodes 10. For example, the consensus may be expressed as a percentage of all nodes 10 that must agree (e.g., 51% or greater), a particular number of nodes 10 that must agree, or other metric.

To implement consensus decisioning, a node 10 (i.e., the bcp 20 operating on the node) may share its own decision (based on programmatic rules of a relevant portion of the bcp 20) with other nodes 10 in the network via messaging system 28. Each node 10 may obtain the decisions of other nodes 10 in the network based on messages received via the messaging system 28. For example, a first node 10 may provide a first message containing a first decision and first node identifier to other nodes 10 to which the first node is connected. A second node 10 may do the same, and may, in certain instances, provide the first message to other nodes to which the second node is connected as well. Such messages may be written to the blockchain ledger 12. In this manner, a given node 10 in the network may have knowledge of the decision of other nodes 10 in the network. When a consensus decision is made, it may be recorded to the blockchain ledger 12, which may cause each node 10 to implement the decision.

By implementing consensus decisioning, the bcp 20 improves the security and distributed nature of making decisions. A malicious actor would need to compromise a consensus proportion or number of nodes 10 in order to influence decisions. This is highly unlikely, and mitigates the security risk of one or even several nodes 10 being compromised.

### Points of Pseudo-Centralization

Once a consensus decision has been determined, each node 10 (each bcp 20 operating on a node 10) will implement the decision. In some instances, the consensus decision may be written to the blockchain ledger 12. As will be described below, the bcp 20 may implement consensus decisioning for determining a cryptocurrency exchange rate, determining interventive actions to take (e.g., expand or contract the basecoin supply), and/or other decisions to be collectively made by a plurality of nodes 10.

### Basecoin Oracle—Secure Cryptocurrency Evaluation Resistant to Individual Node Vulnerability

The bcp 20 may include an oracle subsystem 22 that obtains a current exchange rate of the subject cryptocurrency based on input from at least some of the plurality of nodes 10. In some instances, the current exchange rate may indicate an exchange rate (“ER”) that indicates a value of the cryptocurrency measured against another unit of value (e.g., a fiat currency, a basket of goods, another cryptocurrency, an asset index, etc.). For example, the oracle subsystem 22 may obtain, from a user of a distributed node 10, an indication of the exchange rate of the subject cryptocurrency. Each oracle subsystem 22 of each node 10 operated by a user may similarly obtain such an indication. Based on the collective indications from the plurality of the nodes 10, the cryptocurrency system may evaluate the cryptocurrency exchange rate. Thus, evaluation of the cryptocurrency exchange rate may be performed in a distributed manner based on input from a plurality of the computer nodes 10.

Referring to FIGS. 1-3, in an implementation, each oracle subsystem 22 (of a node 10) may periodically (e.g., daily) receive a exchange rate indication such as an ER from a user of the node 10 on which the oracle subsystem 22 operates. The oracle subsystem 22 may do so by providing a voting interface via the basecoin wallet 14 to a user of the node 10. Put another way, a user of node 10 may use the basecoin wallet 14 to input that user's vote (i.e., indication) of the current ER. Each oracle system 22 may use the messaging system 28 to broadcast its received ER vote to other nodes of the cryptocurrency network.

A peer-derived indication of the ER may then be generated based on the ER votes received from the plurality of nodes 10. For example, each oracle subsystem 22 may receive ER votes from other nodes 10, and then select the median value of the ER from amongst the ER votes. In this manner, in order to influence the ER, a malicious actor would have to compromise over half of the nodes 10. Furthermore, the oracle subsystem 22 may implement secure consensus decisioning in order to determine the ER. For instance, each node 10 may determine the median ER and if a consensus number of nodes 10 agrees (after each node also determines the median ER), then a consensus ER may be reached and is used as the current ER. The determined ER may be written to the blockchain ledger 12. The current ER may be used in interventive decisioning processes described below.

In some instances, a given ER vote may be weighted. For example, an ER vote may be weighted based on a value or number of basecoins in a user account of a user that operates a node 10, through which the ER vote is obtained. The median value of the ER may therefore reflect a coin-weighted median of all coin-weighted ER votes. Alternatively or additionally, an ER vote may be weighted based on a value or number of baseshares in a user account. In this case, the median value of the ER may therefore reflect a coin-weighted and/or share-weighted median of all coin-weighted and/or share-weighted ER votes.

Calculating the ER value over time

In some implementations, the ER may be calculated over a period of time, which may improve the security of the ER determination (which such security risk is inherently derived from the distributed computing nature of determining the ER as described herein).

For example, the system may compute the average daily volume of ER votes over the last month. Call this the MADV (monthly average daily volume). The system may compute the 24-hour volume-weighted average price for each exchange in your oracle set. Call this the VWAP (volume-weighted average price). The system may then compute the price as the median of all the VWAPs, where each exchange's VWAP is weighted by the MADV.

The foregoing may weights each exchange using MADV, which is a long-run value that is resistant to the nodes 10 being compromised. In order to influence the median, a malicious actor would need to manipulate roughly half of the volume across all exchanges for a day, which is computationally expensive and difficult to do.

### Encouraging ER Votes

To some extent, the security of the distributed system of voting may depend on the number of nodes 10 that actually participate in voting. For instance, if only a small portion of nodes actually votes, the likelihood of being able to compromise 50 percent (or other consensus value) of the voting can be high. To encourage ER voting, and therefore increase the security of the ER votes, a penalty may be assessed on a basecoin holder who does not vote. For example, a user account of a user operating node 10 that does not provide a certain number of ER votes in a given time period (such as a year) may be assessed a penalty of 10 percent (or other proportion or amount) of the value of the user account at the end of the time period. Alternatively or additionally, a penalty may be assessed on a periodic (e.g., daily) basis if an ER vote is not received. In other examples, an ER vote may be encouraged by providing a benefit to voting. Such benefit may include provision of one or more tokens described herein, advancing in a queue, and/or other benefit.

### Delegating ER Votes

In some instances, the system may further encourage voting by making it easier to vote through the use of vote delegation. The system may enable a basecoin holder to delegate its votes to a “delegate” node 10 (i.e., to a basecoin holder operating the delegate node 10). For example, when a user sets up a basecoin wallet on a node 10, the system may enable the user to select one or more delegates that the user believes will reliably upload votes properly. The user can then delegate their basecoin wallet's votes to that delegate. In some instances, delegates may receive a fee and/or other compensation for their service.

In some implementations, the system may store and provide a listing of delegates via the basecoin wallet 14. To gather such list, the system may allow delegates to broadcast their information to the blockchain ledger 12 via messaging system 28. Such delegates may do so to obtain voters and thus more fees. Alternatively or additionally, the system may scan the history of votes in the blockchain ledger 12 for delegates. Still alternatively or additionally, the basecoin wallet 14 may randomly select delegates. In some of these instances, the basecoin wallet 14 may randomly select delegates from a pool of delegates that have a number of votes that do not exceed a predetermined number of votes. In this manner, a given delegate may not be able to amass too many voters. Other methods of automatically selecting without user input and/or selecting and presenting delegates for selection by a user may be used as well. The system may enable a user to modify, delete, or add delegates upon request or the system may automatically do so if (for example) a given delegate is amassing too many votes beyond a predetermined number or percentage.

### Encouraging Accurate ER Votes

In an implementation, to encourage truthfulness of votes, the system may impose a penalty on basecoin holders that provide votes of ER values that are outside some band around the median. Such penalty may be in the form of a number or percentage of basecoins. The penalty may be fixed by a predefined number and/or may be dynamically generated based on how much a ER value of a vote deviates from the median ER value. More specifically, this penalty may result in a stronger Nash equilibrium around the truthful value. The penalty may allow for shifts in the median, but tests alternate ER values outside the median by penalizing them until they succeed (e.g., become the median).

In some instances, a target exchange rate may be encoded by the bcp 20. To the extent that the cryptocurrency exchange rate determined by the oracle subsystem deviates from the target exchange rate by a threshold value, the bcp 20 may intervene so that the target exchange rate is restored, or at least restored within the threshold value. The target exchange rate may be written to the blockchain.

### Intervening to Stabilize the Cryptocurrency

Generally speaking, the bcp 20 may programmatically intervene by automatically increasing or decreasing the supply of the subject cryptocurrency in a distributed fashion. For example, the bcp 20 (e.g., via an intervention module) may generate one or more units (or portions of a unit) of the cryptocurrency to increase the supply by writing one or more blocks to the blockchain that each indicate the creation of at least a portion of a unit of the cryptocurrency.

On the other hand, the bcp 20 (e.g., via an intervention module) may burn one or more units (or portions of a unit) of the cryptocurrency to decrease the supply by writing one or more blocks to the blockchain that each indicate the destruction or inactivation of at least a portion of a unit of the cryptocurrency. Other ways to create or destroy units of the cryptocurrency may be used, the results of which may be stored on a blockchain, which may be stored at some or all of the nodes.

By generating or burning units of the cryptocurrency, the bcp 20 may programmatically control the quantity of the cryptocurrency in circulation in a distributed (i.e., decentralized) and automated manner. In this way, the bcp 20 may automatically control the quantity of the cryptocurrency to achieve the target exchange rate and/or target level of volatility to address volatility that arises out of the use of blockchain for other cryptocurrencies. As another benefit, the bcp 20 achieves stability without the control of a single (centralized) actor and without subjective judgement calls that can exacerbate such volatility.

The bcp 20 includes built-in rules that programmatically encode triggering events for intervention and intervening behavior to exhibit (e.g., whether and how such intervention is to increase or decrease the supply of the subject cryptocurrency). For example, responsive to a determination that a value of the subject cryptocurrency is too high, the bcp 20 may create additional units of the cryptocurrency. On the other hand, responsive to a determination that a value of the subject cryptocurrency is too low, the bcp 20 may burn units of the cryptocurrency. In other examples, market or other information besides value of the subject cryptocurrency may be used as well. One example of such other information may include market sentiment information, exchange volume, and/or other information that can be used to trigger behavior to exhibit. In some instances the behavior to exhibit may be driven by votes from oracles in an oracle subsystem, which is described below. Generally speaking, the oracles may each cast a vote that indicates a quantity of the subject cryptocurrency that should be increased or decreased (or remain the same). The median quantity may be selected by consensus and this median quantity may be used to alter (or not alter if zero) the supply of the subject cryptocurrency.

By way of illustration and not limitation, examples of cryptocurrency implementations, and programmatic ways in which to intervene in response to the cryptocurrency exchange rate determined by the distributed oracle subsystem will now be described.

### Operational Applications of the Basecoin Cryptocurrency Protocol—Cryptocurrency Tokens

In an implementation, the bcp 20 may use three types of electronic tokens to stabilize a subject cryptocurrency. By managing these three types of tokens and storing transactions relating to these tokens on the blockchain, the bcp 20 may stabilize the subject cryptocurrency in a distributed fashion.

A first type of electronic token may include the subject cryptocurrency, whose value is stabilized by the bcp 20. The first type of electronic token may be used as a medium of exchange. Transactions using this type of electronic token may be recorded on the blockchain in a manner similar to those of other cryptocurrencies like Bitcoin. Although this first type of token may be created and destroyed by the built-in mechanisms of the bcp 20, they do not have a specified expiration date. The first type of token may be referred to herein as a “basecoin.”

A second type of token represents a future claim to a unit of the first token type at some point in the future. For example, the second type of token may be issued to a user if the user agrees to exchange a unit of basecoin owned by the user in order to receive the second type of token. In exchange, the bcp 20 may issue a second type of token to the user, usually with some value add-on to incent the user to accept the second type of token. The unit of basecoin obtained in this manner may be burned. In this way, issuance of the second type of token may reduce the immediate supply of basecoins in circulation, as well as provide a source for increasing the supply at a later date by exchanging the second type of token with the first type of token at a later date. The second type of electronic token may be referred to herein (for convenience as a basebond). Basebonds may be programmatically auctioned off by the bcp 20 when it needs to contract the supply of the first token type. The second token type is not pegged to anything (i.e., does not have a target value as does the first type of token). Each of the second type of token represents a future claim to a unit of the first token type at some point in the future under certain conditions. According to the bcp 20, the time of issuance of each of the second tokens may be recorded to the blockchain. In some instances, each time a second type of token is issued, it is added to a second type of token queue. This queue may be stored in a first in first out (“FIFO”) manner.

Each instance of a second type of token may have an expiration date that is calculable from the recorded issuance date or other expiration that is recorded to the blockchain. The term is determined by the bcp 20, e.g., some set period after an instance of the second toke type was issued.

The second token type is sold on open auction for prices of less than 1 Basecoin, based on user bids. The blockchain causes a number of the first token types to be removed from circulation corresponding to the number of second tokens created. The protocol includes a set of rules defining conditions under which the second tokens are redeemed. The rules are: (i) that the blockchain has determined that an expansion of the first token type supply is necessary; (ii) the term of the instance of a second token type has not expired; and (iii) all of the second token types that were issued before this instance if the second token type have been redeemed or have expired.

A third electronic token may represent a right of its owner to receive a unit of the first type of token, such as when the bcp 20 determines that the supply of the first type of token should be expanded. The supply of the third electronic token may be fixed at the genesis of the blockchain, but the supply may be adjusted up or down over time. For example, the supply may be increased periodically at a predefined rate (such as 5% per year) or decreased periodically at the same or different predefined rate. They are not pegged to anything, and their value stems from a contingent right to receive first types of tokens under certain conditions. For example, when demand for first type of tokens goes up and the bcp 20 creates new first type of tokens to match demand, holders of the third electronic tokens receive the newly-created first type of coins pro rata. The foregoing may be subject to one or more conditions, such as all of the basebonds must have been redeemed beforehand. The second type of electronic token may be referred to herein (for convenience as a baseshare).

### Operational Applications of the Basecoin Cryptocurrency Protocol—Cryptocurrency Contraction

The bcp 20 (e.g., via the contraction module 28) may include various built-in mechanisms for contracting basecoins in circulation responsive to the value of the basecoin falling below a target value and/or other trigger that causes the number of basecoins in circulation to be contracted. By contracting the supply of basecoins, the value of a unit of the basecoin may tend to be increased.

One exemplary mechanism of reducing the basecoin supply is by offering an trade of basebonds for basecoins. The bcp 20 may incent holders of basecoins to give up one or more units of their basecoins and in return receive a basebond. In some instances, a basebond may expire after a fixed time period set by the bcp 20. In some instances, the basebond expiration may be set dynamically based on the value of the basecoin. The bcp 20 may burn the basecoins obtained in this manner.

Issued basebonds may be later exchanged for further basecoins (or other units of value) when the supply of basecoins needs to be expanded. The bcp 20 may maintain a listing of the issued basebonds in a FIFO queue and written to the blockchain. Basebonds may be selected for redemption based on the FIFO queue subject to certain conditions being met (such as when the basebond expires and whether the supply of basecoins should be expanded).

Another exemplary mechanism of reducing the basecoin supply is by offering a trade of baseshares for basecoins. The bcp 20 may incent holders of basecoins to give up one or more units of their basecoins and in return receive a baseshare. Each baseshare may entitle the holder to receive a new supply of basecoins when the bcp 20 determines that the basecoin supply should be expanded. The bcp 20 may then burn the basecoins obtained in this manner. Like the issuance of basebonds, the issuance of baseshares may be stored in a FIFO queue and written to the blockchain.

In some instances, the bcp 20 may cause baseshares to decay at a certain rate, such as 5% per year. Other decay rates may be used as well. For example, a holder of 100 baseshares will hold 95 baseshares after one round of decay at a decay rate of 5%. The bcp 20 may store the decayed baseshares in a baseshare pool that includes baseshares that are available to be sold in exchange for basecoins. The decay event may be written to the blockchain. Thus, the baseshare pool may provide a supply of baseshares that can be exchanged for basecoins, where are then burned to reduce the basecoin supply. As will be described later, the bcp 20 includes an expansion mechanism in which new basecoins are issued pro rata to baseshare holders. Alternatively, the bcp 20 may cause baseshares to be increased at a certain rate. The increase may also be written to the blockchain. In some instances, the baseshares that were increased at the certain rate may be added to the baseshare pool that includes baseshares that are available to be sold in exchange for basecoins.

### Operational Applications of the Bcp 20—Cryptocurrency Expansion

The bcp 20 (e.g., via the expansion module 26) may include various built-in mechanisms for expanding basecoins in circulation responsive to the value of the basecoin rising above a target value. By expanding the supply of basecoins, the value of a unit of the basecoin is decreased.

One exemplary mechanism of expanding the basecoin supply is by redeeming basebonds. In this example, the bcp 20 may provide basebond holders basecoins in exchange of basebonds, according to the FIFO queue recorded on the blockchain. In this manner, the supply of basecoins in circulation is increased as necessary. In some instances the foregoing may be subject to the basebond not having expired. For example, if a basebond has not expired, and it is next in the FIFO queue to be paid, the bcp 20 may provide distributions to it up to its face amount. In some instances, partial redemptions are not permitted; instead, once a partial distribution has been made, the basebond may remain at the front of the FIFO queue. For example, assuming a basebond has a face value of one unit of cryptocurrency on Jan. 1, 2019. On Jan. 1, 2020 an expansion occurs which pays 0.20 units per basebond; on May 1, 2022 there's another that pays 0.75 per basebond. The basebond is still potentially entitled to 0.05. However on Jan. 1, 2025 the basebond may expire and become valueless. In this example, there must have been no additional expansions between May 1, 2022 and Jan. 1, 2025 because once a basebond gets a payment, it remains at the front of the FIFO queue, and will remain there until it's rights are paid in full.

In another exemplary mechanism of expanding the basecoin supply, the bcp 20 may provide new basecoins to holders of baseshares. The bcp 20 may do so pro rata amongst all holders of baseshares. Furthermore, the bcp 20 may provide basecoins to baseshare holders only after there are no basebonds that are available for redemption (e.g., when all unexpired basebonds have already been redeemed for basecoins). It should be noted that issuance of new basecoins to baseshare holders may not require the baseshare holders to provide anything in return (other than being a baseshare holder). It should also be noted that the baseshares in the baseshare pool resulting from baseshare decay are not provided with basecoins; only actual baseshare holders are provided with basecoins.

### Regional Basecoin for Each Regional Economy

In some implementations, the bcp 20 may maintain a separate cryptocurrency for different regions. For example, each regional economy to have its own bcp 20 that can respond independently to local demand shocks. This is because demand shocks can concentrate in a particular region, almost in complete isolation from the rest of the world. In some implementations, the different regions may be associated with their own cryptocurrency pegged to the same value (e.g., fiat currency, basket of goods, etc.) as another region's cryptocurrency or different value. For example, the bcp 20 may peg each of two regions' cryptocurrency against a U.S. dollar or the same basket of goods. Alternatively, the bcp 20 may peg one region's cryptocurrency against one fiat currency or basket of goods but peg another region's cryptocurrency against another fiat currency or basket of goods.

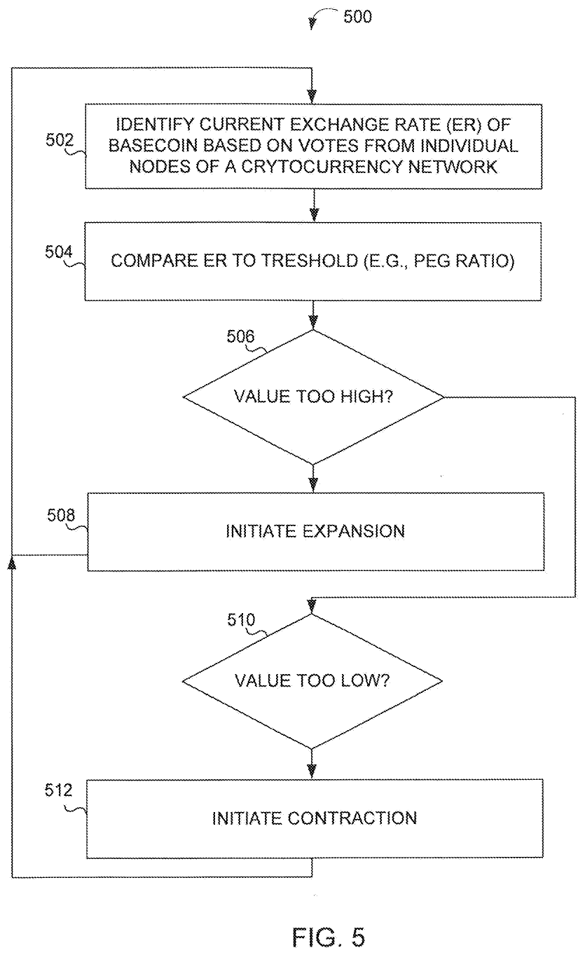

FIG. 5 illustrates a process 500 for stabilizing the value of a cryptocurrency, according to an implementation of the invention.

In an operation 502, process 500 may include obtaining a current exchange rate of a cryptocurrency (e.g., basecoin) based on votes from individual nodes of a cryptocurrency network. In an operation 504, process 500 may include comparing the ER to a threshold value, such as a peg ratio. In an operation 506, process 500 may include determining whether the ER is too high (i.e., the ER is higher than the threshold by a predetermined amount, assuming that the ER is a measure of the value of the cryptocurrency relative to another unit of value) based on the comparison. If yes, then in an operation 508, process 500 may include initiating an expansion of the cryptocurrency by electronically issuing newly created units of the cryptocurrency. If no, in an operation 510, process 500 may include determining whether the ER is too low. If the ER is too low, in an operation 512, process 500 may include initiating a contraction of the cryptocurrency by electronically deleting or rendering inactive units of the cryptocurrency. Process 500 may periodically be repeated, thereby ensuring that the ER of the cryptocurrency is stabilized over time.

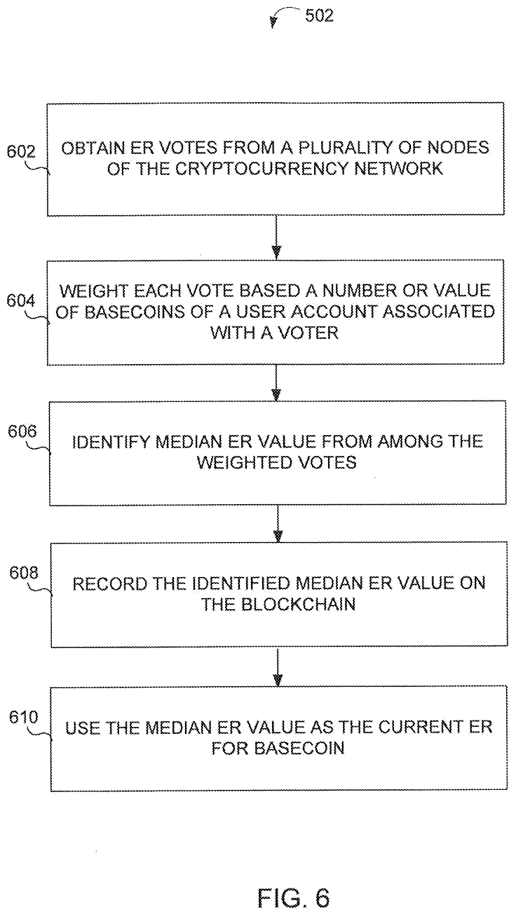

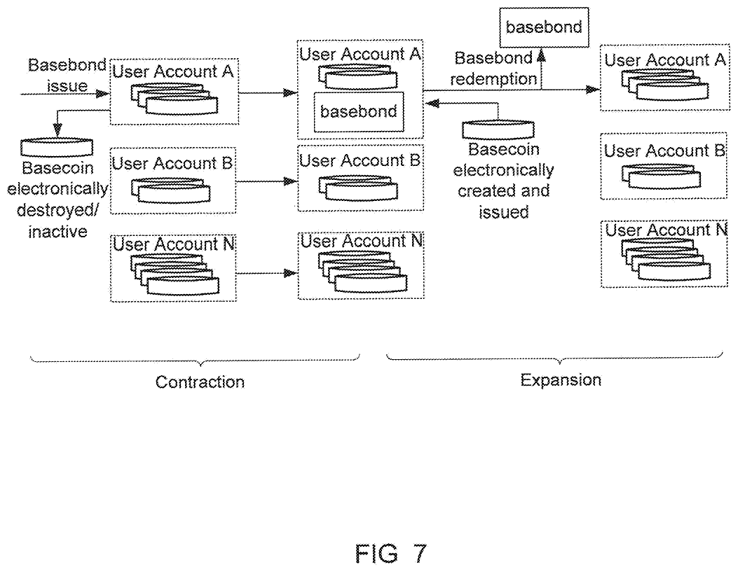

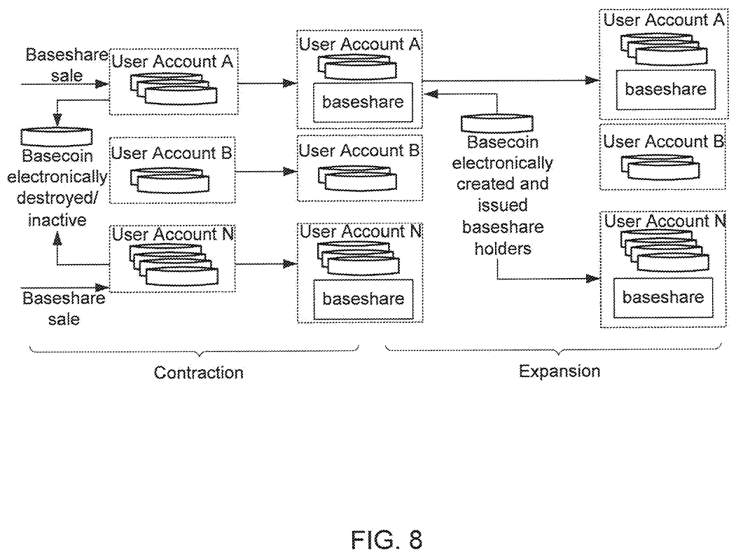

FIG. 6 illustrates a process 600 for obtaining an exchange rate that indicates a value of a cryptocurrency relative to another unit of value from a plurality of nodes of a cryptocurrency network, according to an implementation of the invention.

In an operation 602, process 600 may include obtaining ER votes from a plurality of nodes of the cryptocurrency network. In an operation 604, process 600 may include weighting each vote based on a value of a user account that provided a given vote (e.g., weighted based on the number of basecoins owned by a user who provided the vote). In an operation 606, process 600 may include identifying a median ER value from amongst the ER values indicated in votes. In an operation 608, process 600 may include recording the identified media ER value on the blockchain, such as blockchain ledger 12. In an operation 610, process 600 may include using the median ER value as the current ER value for the cryptocurrency.

Although not expressly illustrated in FIG. 1, each node 10 and webhost may include one or more physical processors that are programmed by computer program instructions. Each node 10 may be programmed by various elements of the bcp 20. Each webhost may be programmed by instructions that interface with and interact with the cryptocurrency network of nodes 10. The various instructions described herein are exemplary only. Other configurations and numbers of instructions may be used, so long as the processor(s) are programmed to perform the functions described herein.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, node 10 may be programmed by one or more additional instructions that may perform some or all of the functionality attributed herein to one of the instructions.

The various instructions described herein may be stored in a storage device of a given node 10 or webhost, which may comprise random access memory (RAM), read only memory (ROM), and/or other memory. The storage device may store the computer program instructions (e.g., the aforementioned instructions) to be executed by the processors as well as data that may be manipulated by the processors. The storage device may comprise floppy disks, hard disks, optical disks, tapes, or other storage media for storing computer-executable instructions and/or data.

One or more databases may be used by, for example, the web host and other system components outside the blockchain. described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

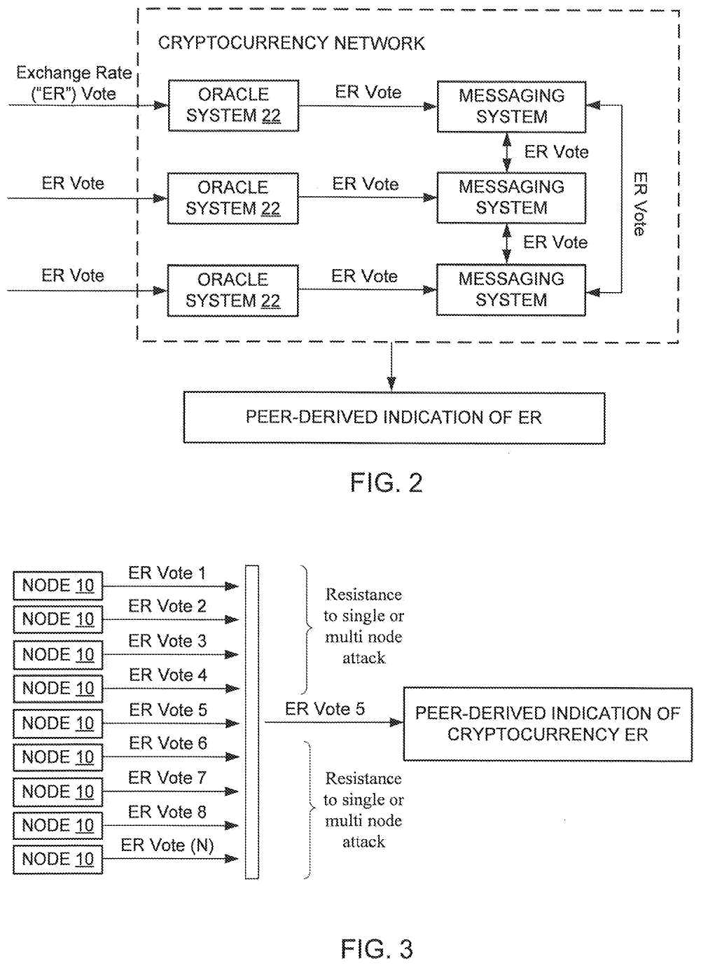

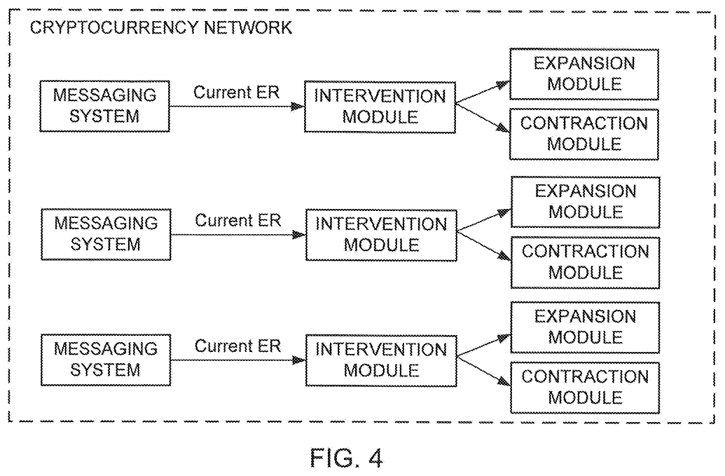

The various processing operations and/or data flows depicted in FIG. 2 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Although described herein as an improved technology for stabilizing the value of a cryptocurrency, the systems and methods may be used to stabilize other types of electronic units of value that are not centrally managed by, for example, a central bank.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system of decentralized control of a quantity of an electronic cryptocurrency in circulation in a cryptocurrency network of one or more physical computer nodes each storing a distributed ledger and each programmed with a cryptocurrency protocol that specifies decisions to be made by the cryptocurrency network, wherein the electronic cryptocurrency is implemented as a first type of electronic token in which ownership is stored on a distributed ledger and a quantity of the first type of electronic token in circulation is controlled via a second type of electronic token that represents a future claim to a value of the first electronic type and a third type of electronic token that represents a right of its holder to receive a value of the first type of electronic token, the system comprising:
at least a first physical computer node comprising one or more storage devices configured to store the distributed ledger, and one or more physical processors programmed with computer program instructions, including the cryptocurrency protocol, that program the first physical computer node to:
identify a triggering event that indicates that the quantity of the first type of electronic token in circulation should be adjusted;
generate a decision to either contract or expand the quantity of the first type of electronic token in circulation based on the identified triggering event;
responsive to the decision, generate an interventive action that either: (i) issues a unit of the second type of electronic token to a holder of a unit of the first type of electronic token in exchange for the unit of the first type of electronic token in order to contract the quantity of the electronic cryptocurrency in circulation, or (ii) identifies one or more holders of the third type of electronic token and issues, to the one or more holders of the third type of electronic token, one or more units of the first type of electronic token in order to expand the quantity of the first type of electronic token in circulation; and
generate a transaction that records the interventive action in the distributed ledger.

2. The system of claim 1, wherein to generate the interactive action, the first physical computer node is programmed to:
determine a number of units of the first type of electronic token that should be either added or removed from the quantity of the first type of electronic token in circulation;
generate a vote comprising the number of units;
provide the vote to the cryptocurrency network, wherein the quantity of the first type of electronic token in circulation is adjusted based on the vote and at least a second vote of at least one other node in the cryptocurrency network.

3. The system of claim 2, wherein the quantity of the first type of electronic token in circulation is adjusted based on a median of the quantity of the first type of electronic token specified by at least the vote and the second vote.

4. The system of claim 2, wherein the cryptocurrency protocol specifies which of the one or more physical computer nodes of the cryptocurrency network are permitted to vote, and wherein the first physical computer node is programmed to determine that it is permitted to provide the vote based on the cryptocurrency protocol.

5. The system of claim 4, wherein the cryptocurrency protocol specifies that holders of the second electronic type of token or holders of the third type of electronic token are permitted to vote.

6. The system of claim 2, wherein the cryptocurrency protocol specifies a reward for voting, and wherein the first computer node is programmed to:
identify at least one physical computer node that has voted within a predefined time period; and
cause the reward to be provided to the at least one physical computer node.

7. The system of claim 2, wherein the cryptocurrency protocol specifies a penalty for not voting, and wherein the first computer node is programmed to:
identify at least one physical computer node that has not voted within a predefined time period; and
cause the penalty to be imposed on the at least one physical computer node.

8. The system of claim 1, wherein the cryptocurrency protocol specifies that a number of the third type of electronic token should be increased at a certain rate over a period of time and that the number of the third type of electronic token is to be added to a pool of the third type of electronic token and made available for exchange for the first type of electronic token.

9. The system of claim 1, wherein the cryptocurrency protocol specifies that a number of units of the third type of electronic token should be decreased at a certain rate over a period of time and removed from each account of each holder of the third type of electronic token and wherein a total quantity of the third type of electronic token removed from each account of each holder of the third type of electronic token is added to a pool of the third type of electronic token and made available for exchange for the first type of electronic token.

10. The system of claim 1, wherein to generate the interventive action, the first physical computer node is programmed to:
responsive to the decision, generate an interventive action that either: (i) issues a unit of a second type of electronic token to a holder of a unit of the first type of electronic token in exchange for the unit of the first type of electronic token in order to contract the quantity of the electronic cryptocurrency in circulation, or (ii) identifies one or more holders of a third type of electronic token and issues, to the one or more holders of the third type of electronic token, one or more units of the first type of electronic token in order to expand the quantity of the first type of electronic token in circulation.

11. The system of claim 1, wherein the decision to either contract or expand the quantity of the first type of electronic token in circulation comprises a decision to expand the quantity, and wherein the cryptocurrency protocol specifies that a number of units of the first type of electronic token in circulation to be expanded is provided to the one or more holders of a third type of electronic token pro rata.

12. The system of claim 1, wherein the decision to either contract or expand the quantity of the first type of electronic token in circulation comprises a decision to contract the quantity, and wherein the unit of the second type of electronic token issued to the holder of the unit of the first type of electronic token is added to a First-In-First-Out (“FIFO”) queue with other units of the second type of electronic token, and wherein to expand the quantity of the first type of electronic token at a later time, the cryptocurrency protocol specifies that a first one of the second type of type of electronic token in the FIFO queue is to be provided with at least a portion of a face value of the second type of type of electronic token so long as the first one of the second type of type of electronic token in the FIFO queue has not expired.

13. The system of claim 12, wherein to specify that the first one of the second type of type of electronic token in the FIFO queue is to be provided with at least a portion of the face value of the second type of type of electronic token the cryptocurrency protocol specifies that a first portion of the face value should be paid out at a first time as part of a first decision to expand the quantity of the first type of electronic token in circulation, maintain a position of the first one of the second type of type of electronic token in the FIFO queue so long as the first one of the second type of type of electronic token continues to have value and has not expired, and specifies that a second portion of the face value should be paid out at a second time as part of a second decision to expand the quantity of the first type of electronic token in circulation.

14. The system of claim 1, wherein the cryptocurrency protocol specifies that a threshold value and a predefined amount of deviation from the threshold value that is acceptable, and wherein the triggering event comprises a detection of a value of the first type of electronic token has deviated from the threshold value by at least the predefined amount.

15. The system of claim 14, wherein the threshold value is pegged to a unit of value other than the first type of electronic token, the second type of electronic token and the third type of electronic token.

16. The system of claim 15, wherein the unit of value comprises a value of a fiat currency or a value of a basket of goods.

17. The system of claim 16, wherein the cryptocurrency protocol is specific to at least a first geographic region and is separate from a second cryptocurrency protocol, specific to at least a second geographic region, that is identical to the cryptocurrency protocol other than the unit of value to which the first type of electronic token is pegged.

18. A computer implemented method of decentralized control of a quantity of an electronic cryptocurrency in circulation in a cryptocurrency network of one or more physical computer nodes each storing a distributed ledger and each programmed with a cryptocurrency protocol that specifies decisions to be made by the cryptocurrency network, wherein the electronic cryptocurrency is implemented as a first type of electronic token in which ownership is stored on a distributed ledger and a quantity of the first type of electronic token in circulation is controlled via one or more other type of electronic tokens, the method comprising:
at least a first physical computer node comprising one or more storage devices configured to store the distributed ledger, and one or more physical processors programmed with computer program instructions, including the cryptocurrency protocol, that program the first physical computer node to:
identifying, at least a first physical computer node comprising one or more storage devices configured to store the distributed ledger, a triggering event that indicates that the quantity of the first type of electronic token in circulation should be adjusted;
generating, by the first physical computer node, a decision to either contract or expand the quantity of the first type of electronic token in circulation based on the identified triggering event;
responsive to the decision, generating, by the first physical computer node, an interventive action that either: (i) issues a unit of a second type of electronic token to a holder of a unit of the first type of electronic token in exchange for the unit of the first type of electronic token in order to contract the quantity of the electronic cryptocurrency in circulation, or (ii) identifies one or more holders of a third type of electronic token and issues, to the one or more holders of the third type of electronic token, one or more units of the first type of electronic token in order to expand the quantity of the first type of electronic token in circulation; and
generating, by the first physical computer node, a transaction that records the interventive action in the distributed ledger.

19. A system of decentralized control of a quantity of an electronic cryptocurrency in circulation in a cryptocurrency network of one or more physical computer nodes each storing a distributed ledger and each programmed with a cryptocurrency protocol that specifies decisions to be made by the cryptocurrency network, wherein the electronic cryptocurrency is implemented as a first type of electronic token in which ownership is stored on a distributed ledger and a quantity of the first type of electronic token in circulation is controlled via one or more other type of electronic tokens, the system comprising:
at least a first physical computer node comprising one or more storage devices configured to store the distributed ledger, and one or more physical processors programmed with computer program instructions, including the cryptocurrency protocol, that program the first physical computer node to:
identify a triggering event that indicates that the quantity of the first type of electronic token in circulation should be adjusted;
generate a decision to either contract or expand the quantity of the first type of electronic token in circulation based on the identified triggering event;
responsive to the decision, generate an interventive action that either: (i) issues a unit of a second type of electronic token to a holder of a unit of the first type of electronic token in exchange for the unit of the first type of electronic token in order to contract the quantity of the electronic cryptocurrency in circulation, or (ii) issues one or more units of the first type of electronic token; and
generate a transaction that records the interventive action in the distributed ledger.

20. The system of claim 1, wherein the decision to either contract or expand the quantity of the first type of electronic token in circulation comprises a decision to expand the quantity, and wherein the cryptocurrency protocol specifies that to expand the supply, the cryptocurrency network issues the one or more units of the first type of electronic token to at least the holder of the unit of the second type of electronic token.

21. The system of claim 20, wherein the cryptocurrency protocol specifies that to expand the supply when there are no unexpired units of the second type of electronic token, the cryptocurrency network issues one or more units of the first type of electronic token to holders of a third type of electronic token.
